(19) United States
(12) Patent Application Publication
(10) Pub. No.: US 2005/0132231 A1
(43) Pub. Date: Jun. 16, 2005

(54) Administration of computing entities in a network

(76) Inventors: Matthew Murray Williamson, Palo Alto, CA (US); Andrew Patrick Norman, Bristol (GB); Jonathan Griffin, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/004,349

(22) Filed: Dec. 3, 2004

(30) Foreign Application Priority Data
Dec. 11, 2003 (GB) 0328692.9

(51) Int. Cl. H04L 9/00

(52) U.S. Cl. 713/201

(57) ABSTRACT

A computer program product for monitoring a user computing entity's status, the program being adapted to: evaluate one more parameters of operation of one more functional elements of the user entity; if an evaluated parameter has a value outside of a predetermined range which is indicative of normal user entity behaviour, operate the user entity to enable, in a predetermined manner, administrative access to the user entity to be gained by an administrative computing entity, thereby to permit the administrative entity to perform an administrative operation on the user entity.

### BACKGROUND TO THE INVENTION

1. Field of the Invention

The present invention relates to the administration of computing entities within a network, a typical example of which is the administration of a plurality of computing entities (which are typically PCs) within a corporate intranet. Administration of both computing entities and the network within which they are located involves the performance of a wide range of activities having varying degrees of complexity, from the provision and maintenance of server computing capability (such as web servers, or mail servers, for example) to user entities and the provision and maintenance of networking infrastructure (cabling, routers, switches etc.), to the ostensibly simpler and technically less demanding tasks involved in trouble-shooting malfunctions experienced by user computing entities. Many of the types of task involved in resolving difficulties or malfunctions experienced by user entities can be performed by a user remotely, via the network; self-evidently this is advantageous because it saves on time required to travel to the physical location of the user entity.

2. Description of Related Art

Administration may involve the configuration (whether ab initio or by modification) of what may be termed an entity's “fundamental” resources (e.g. the operating system, network card drivers, firmware, desktop firewall), i.e. those resources whose operation are either seminal to the overall ability of an entity to function, or which have an effect upon the proper operation of many of that given entity's other resources. Access to such fundamental resources is, unsurprisingly therefore, privileged, and when gaining such access remotely a secure connection is required in order not unduly to compromise that security. Typically a single genus of secure connection and a single authentication (e.g. usemname and password) are employed for all entities in the network, since this provides economy of scale and simplicity of maintenance. One example of such access is the use of a Secure Shell (SSH) interface program, which provides secure encrypted communications between two un-trusted computing entities using Linux or Unix operating systems over an insecure network. Using SSH an administrator can log into, and execute commands on, a remote computing entity. An alternative interface is the Remote Desktop software provided for use with a user entity having a Microsoft Windows® operating system, which gives a remote administrator access to the command prompt of a user entity.

There are however aspects to the provision of such secure remote access to an administrator (and in this context the term “administrator” is intended to encompass, as the context requires, the person or people who administer, the computing entities used for administration, or a combination of both) which amplify the vulnerability of the network as a whole to malicious attack, whether as a result of viral attack, hacking or malicious behaviour by a rogue administrator. A single genus of secure connection having a single mode of authentication creates a situation in which a successful attack (whether by a virus or a hacker) on the integrity of either of the connection or the authentication process results in the provision of privileged access to the fundamental computing resources of all entities on the network which are managed using such a connection and authentication. The potential consequences of failure of such security are therefore severe.

### SUMMARY OF THE INVENTION

A first aspect of the present invention provides a method of administering a network having a user and an administrator entity, the method comprising the steps of:
operating the user entity to enable administrative access for the administrative entity via network using a secure connection;
operating the user entity to disable the secure connection;
evaluating, at the user entity, one more parameters of operation of one or more functional elements of the user entity; and
if a parameter lies outside a predetermined range, operating the user entity to enable the secure connection.
   Other aspects of the invention are set out in the claims and description, as appropriate.

### BRIEF DESCRIPTION OF DRAWINGS

Embodiments of the present invention will now be described, by way of example, and with reference to the accompanying drawing, in which:

FIG. 1 is schematic representation of a network of computing entities;

FIG. 2 is a schematic representation of the salient functional elements of a typical user computing entity;

FIG. 3 is a flow-chart illustrating a sequence of diagnostic polling operations performed to establish abnormal behaviour in a user computing entity;

FIG. 4 is a schematic illustration of the architecture of an administered computing entity during normal operation, in accordance with an embodiment of the present invention;

FIG. 5 is a schematic illustration of a component of FIG. 4;

FIG. 6 is a schematic illustration of the architecture of an administered computing entity during abnormal operation, in accordance with an embodiment of the present invention; and

FIG. 7 is flow chart illustrating interaction of a user computing entity with an administrating computing entity in accordance with an embodiment of the present invention, to enable the latter to gain administrative access to the former.

### BRIEF DESCRIPTION OF DRAWINGS

Referring now to FIG. 1, a plurality of user computing entities 10 and a server computing entity 12 are located within an intranet 16 of a commercial organisation and together form a network. The network is administered by an administrative computing entity 20. The presence of an intranet is shown here merely to replicate a common commercial scenario and is not a necessary feature in relation to the present invention. Similarly, the location of the administrating entity vis-à-vis the intranet (i.e. whether it is located inside or outside the intranet) is not important.

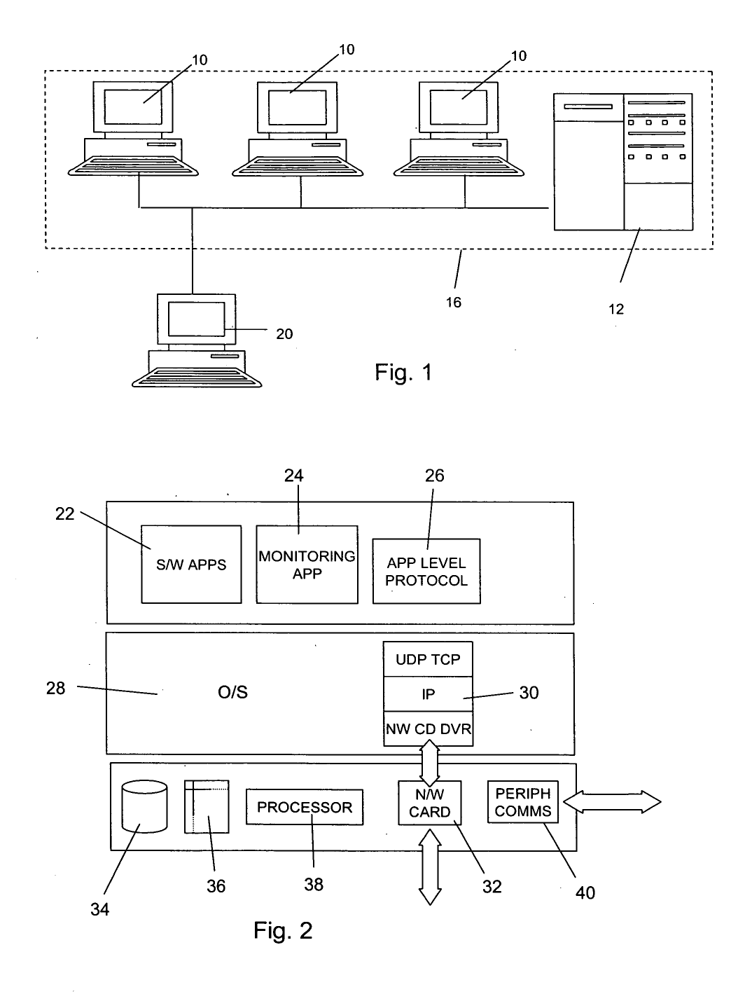

Referring now to FIG. 2, each user computing entity has a substantially similar configuration of functional elements. Specifically this includes: one more software applications 22 (such as word processing software), and in the present example an additional monitoring software application 24, the function of which will be described in more detail subsequently; a plurality of programs 26 whose function may be thought of as implementation of one or more application level communications protocols (such as, for example, HTTP, or FTP); an operating system 28 which, in very simplistic terms performs the function, inter alia of managing the entity's hardware (such as the allocation of storage and memory) for the software applications; a stack 30 of programs which implement low-level communications protocols which interface with a network card 32 to enable communication with other entities in the network; various hardware elements including storage device 34, addressable memory 36, a processor 38 and a plurality of peripheral communications ports 40. The peripheral comms. ports 40 usually serve the purpose of enabling the entity to connect to computer peripheral devices such as a mouse, keyboard, digital camera etc., and examples of such ports include Universal Serial Bus (USB), RS232 serial port, Irda (infra red) port, and a bluetooth port. Thus in this context the term “port” means a physical connection to a computing entity. This should not be confused with the more prevalent useage of the term (and the meaning adopted subsequently in this specification) where “port” is used to mean an eponymous label attached to a packet transmitted through a network.

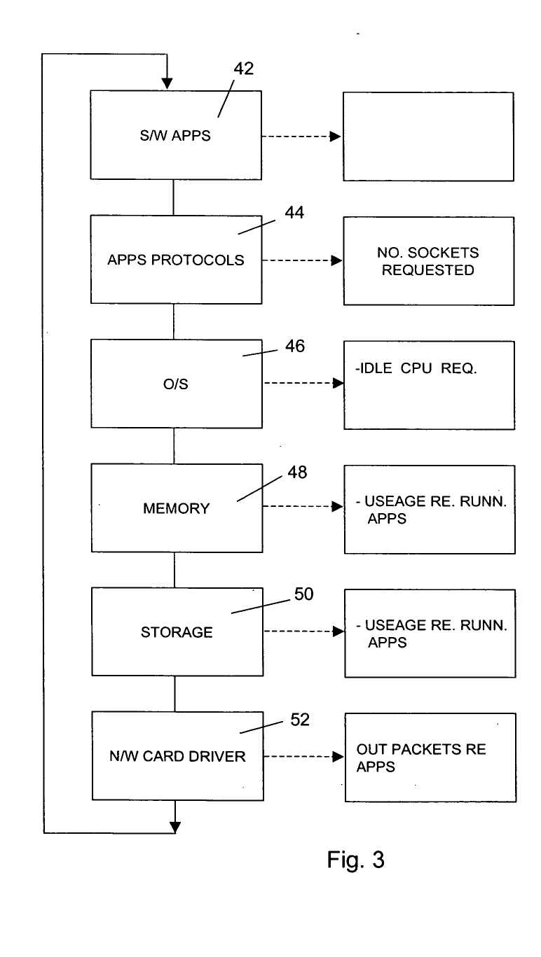

In accordance with an embodiment of the present invention, the monitoring software performs, locally within the a user computing entity, part of the function of a remote network administrator, monitoring the operation of various functional elements within the entity to check whether the behaviour of those elements is normal. Referring now to FIG. 3, the monitoring software 24 does this by sequentially and repeatedly evaluating various performance parameters of various of the user entity's computing elements; in this example those elements illustrated in FIG. 2. The various processes of the evaluation daemon run by the monitoring application 24 include monitoring:
at step 42, the performance of the various software applications, by checking such parameters as the useage of CPU cycles, the sequence of system calls, the number, size and nature of files accessed;
at step 44 the activity of the applications protocols, by checking the number of sockets (which here may be thought of as designated memory space bound to a port number) requested over a given time interval;
at step 46 the operating system, by checking the amount of processor capacity taken up by a system idle process;
at step 48 memory useage, which is evaluated in comparison to the number and nature of software applications running the time of the evaluation;
at step 50 useage of storage capacity, which, as with the memory evaluation, is evaluated in comparison to the number and nature of software applications running;
at step 52 the performance of the network card, by checking the number of packets sent out in comparison to the number of sockets requested by applications software, for example.

If, in the course of evaluation, the monitoring application 24 detects that one or more of the evaluated parameters lies outside a range defined by a policy as normal, it operates to generate a signal, or “flag” indicative of a state defined as abnormal.

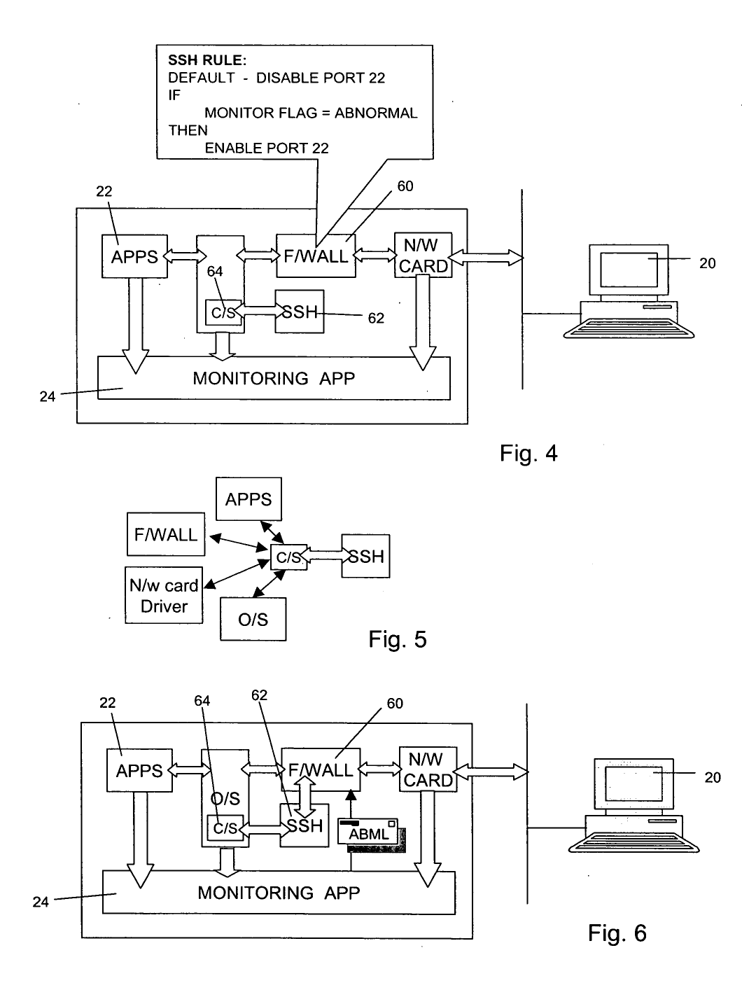

Referring now to FIG. 4, aspects of the functional architecture of a user computing entity 10 which are germane to an illustration of the concepts underlying the present invention are illustrated schematically. Thus data packets from the network enter the user entity 10 via the network card 32, pass through a desktop firewall 60, thence to other resources within the entity, such as the operating system 28 and applications 22 as appropriate. As illustrated generally in FIG. 1, both user and administrative computing entities 10, 20 are connected to a network, and one function of the administrative entity 26 is the performance of administrative operations on computing entity 10. An administrative operation may be defined as an operation which changes the manner in which the administered entityper se operates. Examples of administrative operations include (but are by no means limited to): upgrading a resource (e.g. a new version of a software application, print driver, or some firmware), uninstalling a malfunctioning program (perhaps followed by reinstallation where appropriate), changing a password, configuring a resource in the user entity such as the settings of a web browser, or “installing” a network printer (which process in reality involves establishing a path to the network printer from the user entity, storing and labelling that path to enable future use). A distinction is intended to be drawn herein between changing the manner in which a user entity per se operates, and the manner in which a user entity is able to operate. The former is in essence referring to operations which take place within the entity. The latter includes within its scope circumstances which may occur as a result of events taking place externally of the user entity, and which do not alter the operation of the user entity per se, but do change the manner in which the entity is able to operate vis-à-vis other entities in the network. Thus an example of an event which is does not alter the manner in which a user entity operates, but which does alter the manner in which it is able to operate would be the occurrence of a denial of service attack, originating and taking place externally of the user entity, but having the effect of preventing the user entity from establishing network connections to one or more other entities in the network—in spite of the fact that the “internal” operation of the user entity is unchanged.

To perform such administrative operations remotely the entity 20 must have administrative access to the entity 10, i.e. access which enables the administrative entity to perform one or more administrative operations. The provision of administrative access has a number of aspects. The first aspect is the ability to gain the necessary access to the appropriate, and usually fundamental resources of entity 10; which access is, precisely because the resources in question are often fundamental to its operation, privileged; the practical result of such access being privileged is that some form of authentication is usually required. In situ privileged access is typically authenticated simply by the use of a username and password, for example when the user entity is starting-up, and possibly in addition by the user of secure screensavers requiring the username and password. Remote privileged can be authenticated in the same way. The second aspect is the ability to gain such remote access in a manner which is secure, i.e., the network path between the administrator and user entities is not readily accessible to unauthorised third parties, for example operating as a “man in the middle”. One known way of providing both aspects of such access is by the use of Secure Shells (SSH); an SSH server program 62 running on a user entity 10 and an SSH client program running on an administrating entity 20 cooperate to provide, inter alia, both authenticated access to privileged resources and a secure encrypted link to the interface of such privileged access. The SSH server 62 on the user entity 10 operates, when functional, to connect the administrative entity, via an encrypted link, to the command shell 64 of the operating system 28. As illustrated schematically in FIG. 5, the command shell 64 is an interface, access to which provides, in turn, privileged access to the various fundamental resources of the entity 10, some of which are illustrated in FIG. 5.

In a state of the art network, the SSH connection between an administrative entity and each entity being administered is permanently active, that is to say that the administrator can, at their behest, gain access to any one of, for example the user entities for which it is designated as an administrator. NB although in order to gain access the administrator may need to go through an authentication procedure, the connection is permanently enabled. Referring again to FIG. 4, in accordance with an embodiment of the present invention, the SSH server 62 is operable to establish a connection with another computing entity only via the desktop firewall 60. Practically speaking this means that while the SSH server 62 remains active, a rule, represented schematically at 70, is applied by the firewall 60 to govern the ability of the SSH server 62 to establish a connection with an administrative entity.

As mentioned briefly above, the most common useage of the term “port” in connection with communications refers to a label attached to data packets which identifies the application protocol (and possibly also the software application) governing communications for data packets thus labelled. The port number is used by the receiving computing entity, inter alia to write the data packets to a socket (which is, in essence, an area of memory designated for the ephemeral storage of data packets) which is “bound” or associated with that port number, and from which designated area of memory the appropriate software application can then process them. Usually, and in the present example, communications via an SSH interface use port 22 (although any port number may be used, use of port 22 is in accordance with convention). Accordingly, the rule applied by the firewall 60 blocks all incoming or outgoing data packets on port 22; in practice this takes place by the firewall processing outgoing data packets prior to their being sent to the network card and incoming data packets prior to their passage to a socket, and in each case not transmitting data packets labelled as being sent or received on port 22. This has the effect of blocking all communications to and from the SSH server 62, and effectively closing or rendering inactive the administrative access to the entity in question. This is the case although the SSH server 62 may remain active such that, absent the firewall operating to block the secure connection, a secure connection could be established (although in the embodiment subsequently described this is not the preferred mode of operation). In the event of the monitoring apps detecting an abnormality, the rule operates to allow the passage of packets on port 22, which in turn, will, in due course result in the establishment of administrative access being granted to the administrative entity. This state of affairs is represented schematically in FIG. 6, in which the firewall 60 operates to pass data packets on port 22 to the SSH server (in practice this will be via a socket whose allocation involves the operating system, but from the point of view of the operations relevant to a simple description of the present embodiment of the present invention, this is not germane), and thereby, as a result of the access which the SSH server 62 provides to the command shell 64, administrative access to the entity.

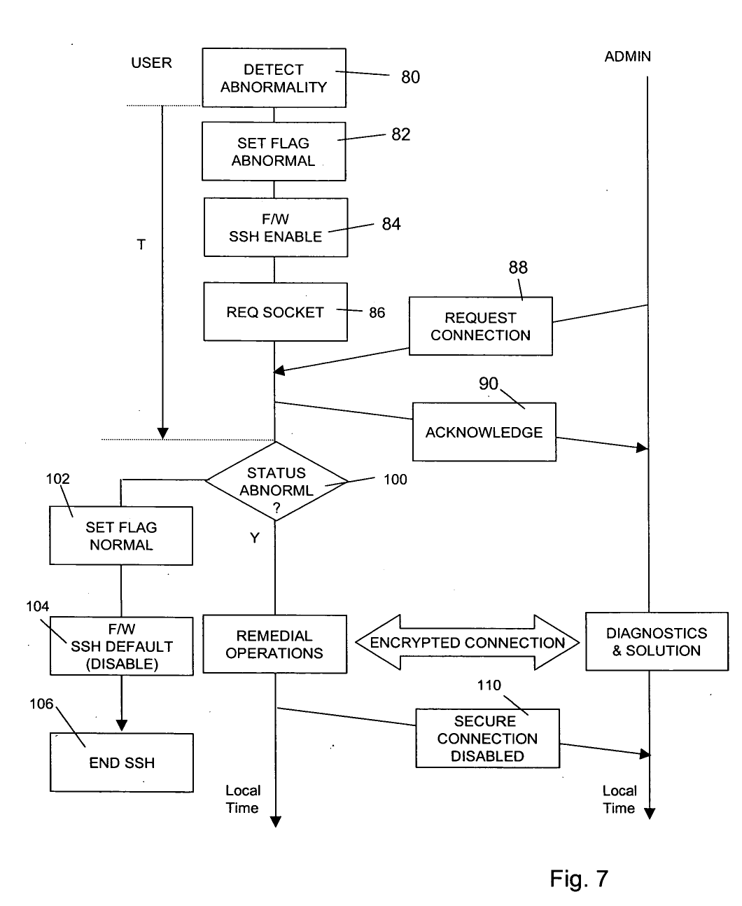

Referring now to both FIGS. 6 and 7, the temporal passage of events set out generally above is illustrated in schematic form and will be described in more detail. Upon detecting that one or more of the evaluated parameters is found to lie outside a range defined as normal at step 80, the monitoring application 24 generates an abnormal flag, this being illustrated schematically in both FIGS. 6 and 7 with reference numeral 82. The flag 82 serves to instruct the firewall that the status is “abnormal” at step 84, so that the rule 70 operates within the firewall to permit the passage of data packets on port 22. The monitoring application then starts the SSH server running at step 86, and at step 86, the SSH server 62 requests a socket. As stated above, a socket can, for the purposes of understanding the present invention, be thought of as a designated memory space which is bound to a defined port number, and thus step 86 (which may be taken to include associated steps—like binding a socket—not illustrated explicitly for the sake of simplicity) is effectively setting the user entity into a state where it is “listening” for a communication having a predetermined port number, here port 22, being the port on which SSH data packets are sent. At step 88, and as part of a regular and repeated sequential investigation of all entities under its care, the administrating entity seeks to establish (in accordance with the standard hypertext transfer protocol) a connection with user entity on port 22. The ability to establish such a connection determining whether the user entity is subject to abnormal behaviour—since if the behaviour is normal then no connection will be possible since the firewall rules block traffic on port 22. If an entity is in a listening state, then the SSH server 62 will, upon receipt of a connection request from the administrator, send an acknowledgment at step 90 (simply part of the http protocol), which indicates to the administrating entity that an administrative access is available to that machine due to an abnormal state. At this juncture the administrating entity and user entity may, at this point, establish a connection (i.e. a shared state between the two entities) on port 22 to facilitate the sending and receiving data packets on port 22, which connection provides the administrating entity with administrative access to the user entity. In one embodiment, subsequent to the establishment of a connection, in order to gain access to one or more of the fundamental computing resources of the user entity, the administrator is then required to perform one or more further verification operations, such as entering a password, for example; this is both usual and desirable, but not essential (whether or not such authorisation is required can usually be configured in the SSH server 62). In any event, diagnosis of the cause of abnormality and any subsequent remedial action can then be taken by the administrator via an encrypted, and therefore secure, link. Once any remedial action is completed, the SSH server 62 then preferably (but not necessarily) broadcasts a data packet to all entities in the network indicating that the SSH connection is now closed (the purpose of such a broadcast will be discussed in more detail later).

Typically, the state of “listening” will persist only for as long as the daemon described with reference to FIG. 3 continues to flag the behaviour state as abnormal. Thus, if subsequently the daemon of FIG. 3 evaluates the behaviour to have returned to a normal state, the access which the state of listening creates will be terminated. Accordingly, at step 100, and a predetermined time interval T (which is typically short) after initially detecting the abnormality, the monitoring application once again outputs a result of the daemon of FIG. 3. If the abnormal state is persistent, then the diagnosis and remedial operations referred to above continue; if the abnormal state is not persistent, then the flag is set to normal at step 102, the firewall applies rule 70 to prevent passage of data packets on port 22, and the connection is thereby disabled. Once connection is disabled, whether because of timeout as shown at step 106, or because the remedial operations are closed, the administered entity broadcasts an SSH closed signal to the network at step 110. In an alternative, once a connection has been established, the recurrence of a normal state is prevented from operating to alter the firewall rules to block traffic on port 22 until a message has been sent to the administrating entity.

In a modification, upon the monitoring application of a user detecting that the user entity behaviour is abnormal, a message is dispatched (this message could be a message to a web server, or even an email) indicating to the administrative entity that the user entity is in an abnormal state, and that it is therefore possible to establish administrative access with it.

In an alternative embodiment, the SSH server 62 is continuously running and the connection is continuously enabled, i.e. the administrator is continuously able to establish a connection to the user, whether or not the two entities are continuously connected via the connection. Administrative access by an administrator is therefore controlled by the ability of an administrator to perform the requisite authorisation process in order to gain access to the necessary resources on the user entity, and this may in turn be achieved simply by configuring the SSH server 62 not to permit authorisation processes to be undertaken unless the machine is flagged as in an abnormal state by the monitoring application. This is not the preferred embodiment, since in the absence of any connection at all to the user computing entity, malicious attacks either by or via the administrative entity on the integrity of the machine are more difficult to perform.

An advantageous aspect of the embodiments described is that, if the monitoring application has threshold levels for evaluation of the operating parameters of the various elements of the entity on which it is operating set at levels which are sufficiently low to flag a very high percentage of abnormal behaviour, it is correspondingly likely that a number of false alarms, or false positive events will be flagged. This is not regarded as particularly detrimental to performance, since the operation of the monitoring application is such that if, as is likely in the event of a false positive, an abnormal state shortly ceases to persist, the flagged state of abnormality is correspondingly reset to normal (e.g. by closing the port on which the “listening” was taking place). Since, in the illustrated embodiment, the administrating entity polls user entities cyclically to establish whether they are in a normal state, a transient false positive may not register with an administrator; alternatively if detected, the abnormal state of the user may revert to normal before administrative connection can be established, so that little wasted effort is expended.

In a further modification, an overriding policy is implemented which serves to limit the maximum number of user entities which can simultaneously enable administrative access to an administrator. Such an embodiment can serve to avoid a potential weakness in the embodiments described above, that if, for example, all entities in the network are infected simultaneously, causing the monitoring application on each one to detect abnormality and thus to provide administrative access simultaneously, there is once again a single access route to all machines useable for example either for the distribution of malicious code, or malicious behaviour by a rogue administrator. To ameliorate this potential weakness, the monitoring application additionally logs the states of all the other administered entities in the local subnetwork (i.e. in this embodiment a subset of the total number of entities in the network, usually defined by a subnet mask in the form of an IP address—although this, or any other limitation on the number of entities is not essential). Each time an entity responds to an administrator's SSH poll (i.e. step 90 in FIG. 7) the monitoring application registers the responding entities state as enabled (using the IP address broadcast in the response. When the administered entity closes its SSH connection and emits, at step 110 in FIG. 7, a signal accordingly, the monitoring application resets its status to disabled. When the total number of entities which are identified in the log as enabled reaches a predetermined number set by policy, the monitoring application will generate an abnormal flag, thus disabling the connection if it is enabled. This has the effect of preventing simultaneous access to a greater proportion of entities than is allowed by the policy. Preferably, the action of disabling enabled connections is taken after a predetermined delay, which is different for each entity; this permits the policy to be enforced locally (i.e. within each user entity), thus limiting vulnerability to central attack, but at the same time prevents the status of the entities in the network oscillating as large numbers of entities simultaneously disconnect and then connect during local policy implementation, as a result of the total number of enabled entities rising above and then dropping back below the threshold set by the policy. Policy parameters, such as the threshold number of enabled entities, and the delay are preferably not adjustable via the remote administrative link, for security reasons. In an alternative embodiment, the policy may be enforced centrally from a server, for example.

The embodiment illustrated described connections, the enablement/disablement of which were permitted because they were to be established on a predetermined port; in other words, if alterations are made at the SSH server 62 and the administrator, such that SSH no longer uses port 22, but some other port, then the disabling of port 22 at the firewall does nothing to prevent connection being established. In an alternative embodiment, the firewall can apply rules which blocks communications from a particular IP address (being that of the administrator), or Media Access Code “MAC” address, and passes data packets from the proscribed IP and/or MAC addresses only when abnormal. This measure can alternatively be used in conjunction with the measures described above for additional security.

The connection via which administrative access is provided has been described in the illustrated embodiments as taking place via the network card, i.e. typically a LAN connection (whether wired or wireless). It is however possible that administrative access could be gained via one of the peripherals ports (the use of the term “port” here connoting a physically existent connection which may be made to the entity, rather than simply as a label attaching to communications travelling through the network). This would be unusual since typically if an administrating entity is able to use such a peripherals port, they are likely to be in sufficient physical proximity to the abnormal entity for an administrator to perform any remedial work directly on the abnormal entity. It is however possible, and the present invention is intended to encompass administrative access gained in such a fashion.

1. A method of administering a network having a user and an administrator entity, the method comprising the steps of:
operating the user entity to enable administrative access for the administrative entity via network using a secure connection;
operating the user entity to disable the secure connection;
evaluating, at the user entity, one more parameters of operation of one or more functional elements of the user entity; and
if a parameter lies outside a predetermined range, operating the user entity to enable the secure connection.

2. A method according to claim 1 further comprising the step of allowing administrative access upon performance by the administrative entity of an authentication process.

3. A method according to claim 1 wherein the secure connection is enabled and disabled by the implementation of a firewall rule.

4. A method according to claim 3 wherein the firewall rule blocks communication on a predetermined port.

5. A method according to claim 1 wherein administrative access enables an administrator to perform one of the following operations: installing software or firmware, uninstalling software or firmware, changing a password, configuring a resource in the user entity, and establishing and labelling a path from the user entity to a network resource.

6. A method according to claim 1 wherein the step of evaluating one or more parameters includes the step of evaluating at least one of: CPU useage, number of sockets requested, system idle requirements, memory useage, storage useage, number of packets dispatched in a given time interval.

7. A method of administering a network having a user and an administrator entity, the method comprising the steps of:
operating the administrator entity to attempt to establish a secure connection with the user entity while the user entity is configured to prevent establishment of such a secure connection
when a parameter of operation of a functional element of the user entity lies outside a predetermined range, operating the user entity to enable establishment of the secure connection by the administrator entity;
operating the administrator entity to establish the secure connection; and
operating the administrator entity to perform an administrative operation on the user entity.

8. A method according to claim 7 further comprising the step of operating the administrator entity to perform an authentication step upon establishment of the secure connection, and before performing the administrative operation.

9. A method according to claim 7 further comprising the step, following performance of the administrative operation, of disabling the secure connection at the user entity.

10. A method according to claim 9 further comprising the step, following disabling the secure connection, of generating and sending a message from the user entity indicating that the secure connection with the administrator entity is disabled.

11. A method according to claim 9 further comprising the step of monitoring a total number of user entities with enabled secure connections at any one time.

12. A method according to claim 11 further comprising the step, in the event of, the total number exceeding a predetermined threshold, of disabling one or more enabled secure connections.

13. A method according to claim 12, wherein the record is maintained within the user entity, and the disabling of a secure connection to a given user entity occurs as a result of operations taking place within that entity.

14. A method according to claim 10 wherein the record is maintained using the message generated from the user entity indicating that the secure connection with the administrator entity is disabled.

15. A method according to claim 13 wherein the network comprises a plurality of user entities, and each one is adapted to disable the secure connection upon the total number exceeding a predetermined threshold after time delay, and wherein at least two user entities have different time delays.

16. A method according to claim 13 wherein all user entities have unique time delays.

17. A method according to claim 7 further comprising the step of the administrator entity performing an authentication step to obtain administrative access.

18. Computer medium having recorded thereon a computer program product adapted to enable remote administration of a user entity, by implementing the steps of:
operating the user entity to enable administrative access for the administrative entity via network using a secure connection;
operating the user entity to disable the secure connection;
in response to a parameter of operation of the user entity lying outside a predetermined range, operating the user entity to enable the secure connection.

19. A computer medium according to claim 17 wherein the program product is adapted to monitor a total number of user entities in a network which enable secure connection at any one time, and if the number of secure connections which are enabled exceeds a predetermined number, disabling the secure connection in the user entity.

20. A method of regulating administrative access to a plurality of user entities by an administrator entity in a network of computing entities, the method comprising the steps of:
establishing administrative access between a user entity and the administrator entity when a parameter of operation of a user entity lies outside a predetermined threshold;
operating the administrator entity to perform an administrative operation on the user entity; and
operating the user entity to disabling the administrative access.

21. A method according to claim 20 wherein establishing administrative access includes the step of establishing a secure connection.

22. A method according to claim 2 wherein the step of establishing administrative access include an authentication step, performed by the administrator entity.

23. A method according to claim 20 further comprising the step of limiting a number of user entities to which administrative access is simultaneously established to a predetermined maximum.
